(19) United States
(12) Patent Application Publication
(10) Pub. No.: US 2006/0076789 A1
(43) Pub. Date: Apr. 13, 2006

(54) Rechargeable hot dog and cook out food roaster

(76) Inventor: Chris Hebert, Stephen, MN (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/175,537

(22) Filed: Jul. 6, 2005

Related U.S. Application Data
(60) Provisional application No. 60/617,424, filed on Oct. 7, 2004.

(51) Int. Cl. A47J 43/18

(52) U.S. Cl. 294/61

(57) ABSTRACT

A novel cookout food cooker comprising; a powered rotisserie device for turning food at a predetermined speed; at least one extendable attachment for supporting a food item to be cooked; and a coupler for affixing the extendable cooking attachments on to the rotisserie device.

### CROSS REFERENCE TO RELATED APPLICATIONS

This application claims benefit to provisional application 60/617,424, filed on Oct. 7, 2004, entitled “Rechargeable Hot Dog and Cook Out Food Roaster” which is incorporated by reference herein in its entirety.

### FIELD OF THE INVENTION

The present invention is directed to the field of hot dog roasters. In particular, the present invention is directed to a rechargeable system for cooking hot dogs, chicken, marshmallows and the like over open fires.

### BACKGROUND OF THE INVENTION

Millions of people go camping each year and enjoy cooking food over an open fire. Among the most popular cookout and campout foods are hot dogs and marshmallows. There have been a number of patents directed to hot dog roasting devices. These have typically involved a variety of grills and skewers. The patent literature has disclosed a number of devices for cooking hot dogs and the like.

U.S. Pat. No. 4,982,657 discloses a manually operated device for supporting and rotating a number of hot dogs above the surface of a grille during a cooking operation. The device is equipped with balancer elements that maintain the device in a stabilized condition on the grilled surface in spite of cantilever forces imposed by the supported hot dogs. An elongated handle is rotatably attached to a housing that mounts a number of rotary hot dog grippers. A gear mechanism within the housing transmits a drive force from the handle to the hot dog grippers.

U.S. Pat. No. 4,355,569 discloses an electric hot dog cooker also suitable for cooking individual portions of sausages, shish kabob or the like, including a stand supporting an electric heating coil in the form of a helix extending horizontally; inside the helical heating coil is a hollow bushing member arranged so that a rotisserie spit rod will extend through the bushing and engage a rotisserie motor element, all essentially co-axial with the helical electric heating element. Secured only to the outer end of the rotisserie spit is a circular arrangement of nine cylindrical open-wire cages about two inches in diameter and about nine inches long, capable of accepting a hot dog, sausage or similar shaped food portion and large enough so that the hot dog will roll in the cage while the circular arrangement of cages is rotated around the heating coil by the rotisserie motor. The motor is shielded from the heating element by a metal shield having a horizontal turned-down portion at the top thereof serving as a warming shelf. An optional cylindrical shield may be fastened around the circular arrangement of cages to reflect heat and conserve energy. The heat level is adjustable electrically.

U.S. Pat. No. 5,054,467 discloses solar hot dog cookers. A dark M-W cross sectioned cylindrical hot dog holder holds at least two hot dogs. The hot dogs are placed on the holder and covered by a dark, solar energy absorbing flat plate. The combination is placed on a plastic base having raised edges to prevent spilling of grease. The base is covered with a top generally transparent to solar energy waves and placed in the sun. Depending on solar intensity, about twenty minutes are usually sufficient to cook the hot dogs. The cooker may then be reused. The cooker also works when solar energy is not at a maximum, such as certain cloudy days, evenings, cold days, etc.

U.S. Pat. No. 6,354,193 discloses a roaster oven for roasting hot dog that includes a roaster oven body, a roast frame and a transmitting device combined together. The roaster oven body has an opening on a top side for the roast frame to fit therein, and the transmitting device is driven to rotate together with rollers inside the roast frame so as to permit food placed on between two rollers rotate automatically to acquire effectiveness of heating and roasting food in a balanced condition.

U.S. Pat. No. 6,518,553 discloses a device for treating sausage in a hot dog dispensing machine that has a substantially closed chamber for receiving a sausage, a unit associated with the chamber and operative for providing a microwave radiation into an interior of the chamber so as to provide cooking of an interior of the sausage, and a unit for generating an infrared radiation arranged outside of an area of the microwave radiation generated by the first unit so as to supply the infrared radiation into the interior of the chamber onto a sausage located in the chamber and therefore to treat a surface of the sausage to provide an exterior skin of the sausage.

U.S. Pat. No. 6,701,827 discloses a device that is described provides rotary placement of a food being roasted over an open heat source such as a campfire. The apparatus is a durable and easy to use food cooker that facilitates the uniform cooking of a food. Food such as hot dogs, wieners, sausages, and ears of corn may be readily placed into the cooking apparatus and roasted over an open fire. The device is adaptable for holding other food items, such as marshmallows, by the use of an accessory holder.

U.S. Pat. No. 6,742,445 discloses an enclosed rotisserie including countertop resting box enclosure housing a safety rear mounted heating element and a power rotated dual rod spit assembly. The gear driven spit assembly may be inserted and removed straight into and out of the enclosure. The spit assembly may also be mounted at various distances from the heating element to decrease cooking times. The open front of the enclosure is covered by an inclined glass panel door. Cooking times are decreased and manufacture simplified by the heating element remaining on constantly during the cooking process. Maintenance is minimized by various parts being removable for cleaning including a cleaning shield located behind the heating element, the glass door, and a drip pan with slotted cover. Accessories include wire baskets and a rotating stir fryer. Self-rotating kabob rods allow for increasing rotisserie capacity by increasing the length of rotating rods available for rotisserie food mounting.

U.S. Pat. No. 4,723,482 discloses a sausage heating machine. A plurality of baskets mounted on a framework of the machine turn with the framework. Each basket has guide members for supporting a sausage. Each guide member includes a main portion on which the sausage can roll as the framework turns. The sausage can fall crosswise of the guide member at leading end portions of the guide members. Hook shaped trailing edge portions of the guide members catch and hold the sausage when the sausage has fallen. Radiant heat is projected crosswise of the framework to heat and cook the sausage as the framework turns.

U.S. Pat. No. 6,754,966 discloses a wienie roaster with prongs that may be folded back. The prongs are pivotably received by a head, and the head is attached at the end of a roaster stalk. The prong has a continuous curve as it enters the head which produces friction to hold the prongs at an adjustable angle away from or towards the roaster stalk. The bore in the head may have beveled, oval-shaped openings, so that the curved base of the prong notches into place in extended and folded back positions. The roaster may also have a tension shoe for applying and distributing pressure on the prongs and a notch in the prongs for receiving the tension shoe. A hole in the top of the head allows lubricant, such as oil or fat from cooking food, to enter the head and lubricate the base of the prong and the tension shoe. The lubrication hole may also be threaded to receive a set screw, which can provide additional pressure to hold the prong in place. In an another alternative embodiment, the base of the prong has notches to receive the tip of the roaster stalk. In this embodiment, the prong is held in its extended and folded back positions when the tip of the stalk enters the notches in the base of the prong. The end of the stalk may be threaded to receive the head, so that the head can be screwed out a little to allow the base of the prong to clear the tip of the stalk, thereby permitting the prong to be swiveled to its extended or folded position. Alternatively, a spring and ball at the end of the stalk can exert enough pressure to hold the ball in the notches of the prong base to hold the prong in position, yet still allow the prong to be swiveled.

It is an object of the present invention to provide a hot dog cooker with interchangeable cooking and roasting attachments.

It is a further object of the present invention to provide a novel cook out food cooker which can be powered by a rechargeable rotisserie.

It is a further object of the present invention to provide a hot dog cooker with replaceable prongs.

### SUMMARY OF THE INVENTION

In accordance with the present invention, a novel cookout food cooker comprising: a powered rotisserie device for turning a food item at a predetermined speed over an open fire; at least one extendable attachment for supporting a food to be cooked; and a coupler for putting cooking attachments on to the rotisserie device.

In a further embodiment, the invention is a novel cookout food cooker comprising: a rechargeable powered rotisserie device for turning a food item to be cooked at a predetermined speed; at least one of plurality of extendable attachments for supporting a food to be cooked; and a coupler for putting the attachment on to the rechargeable powered rotisserie device.

In still a further embodiment, the invention is a novel cookout food cooker comprising; a rechargeable powered rotisserie device for turning a food item to be cooked at a predetermined speed; an extendable arm and a plurality of extendable attachments for the arm, each configured to a support a different food item to be cooked; and a coupler for putting the extendable arm on to the rotisserie device.

### BRIEF DESCRIPTION OF THE FIGURES

FIG. 1 is a side perspective view of the present invention.

FIGS. 2a-2c are perspective views of the replaceable attachments of the present invention.

FIG. 3 is a side perspective view of the present invention of the rotation mechanism of the invention.

FIG. 4 is a coupler in accordance with the invention.

FIGS. 5 and 6 illustrate an arm adapter.

### DESCRIPTION OF THE PREFERRED EMBODIMENT

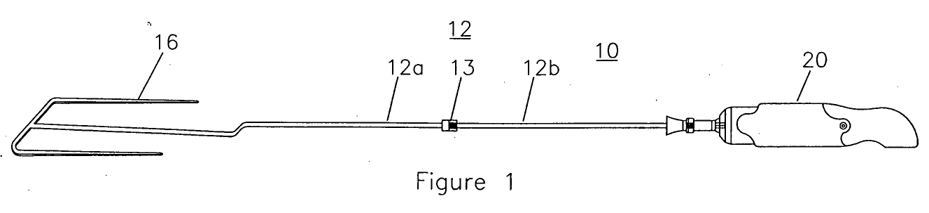

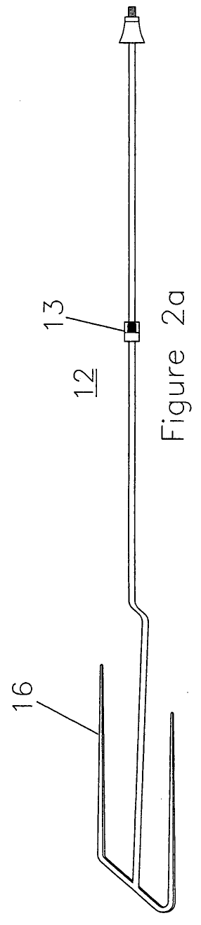

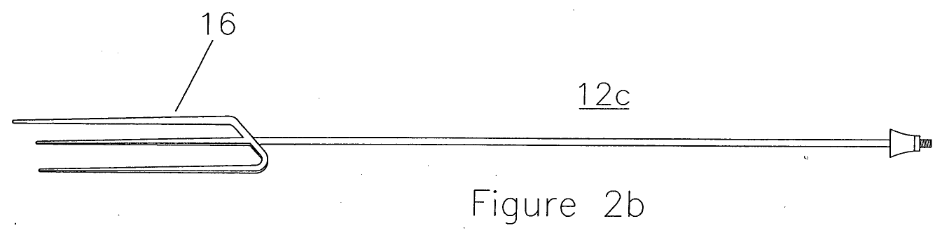

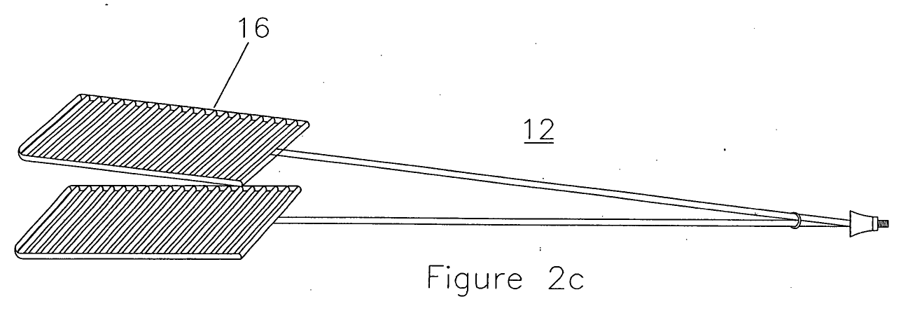

The present invention is described with reference to the enclosed figures wherein the same numbers are used. FIG. 1 shows an extendable and rechargeable hot dog/wiener roaster 10 of the present invention. The invention is designed to rotatably cook a number of foods over an open fire. These foods include most cook-out foods including hot dogs, sausages, chicken, bratwurst, and even hamburgers.

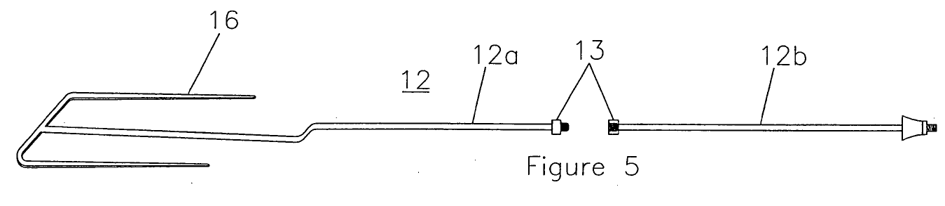

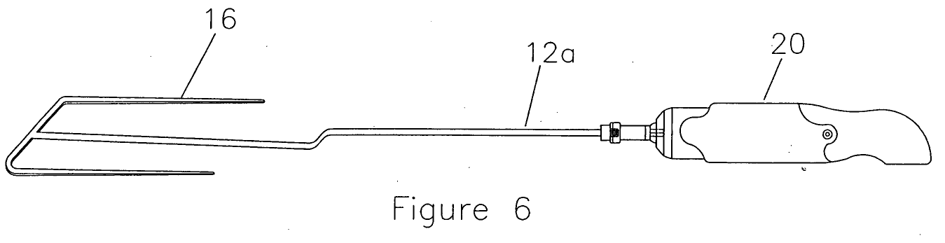

The invention has three principal components including a plurality of extendable attachments 12. The attachments may be designed for a variety of goods, including hot dogs, marshmallows, chicken and burgers. In one embodiment, the device may include an extendable arm 12 with a plurality of attachments 16. As shown in FIGS. 5 and 6, the extendable arm may comprise multiple pieces 12a, connected by a connector 13. FIG. 6 illustrates the use of the invention with a shortened arm.

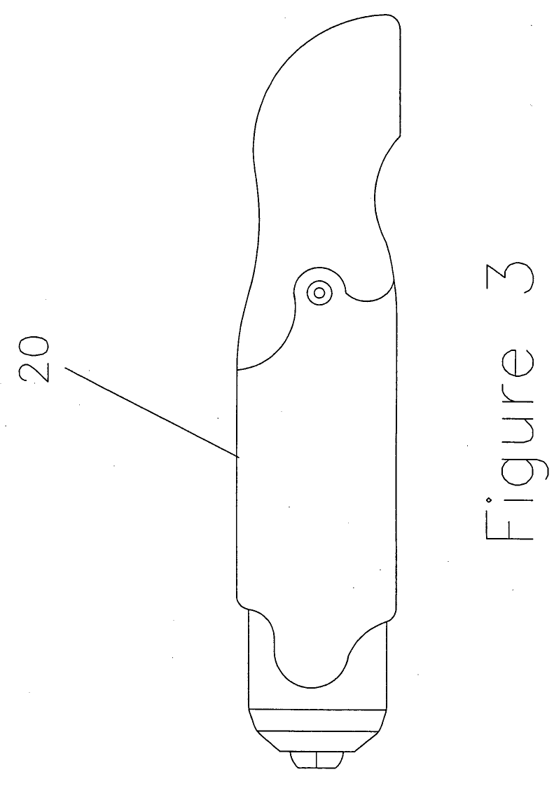

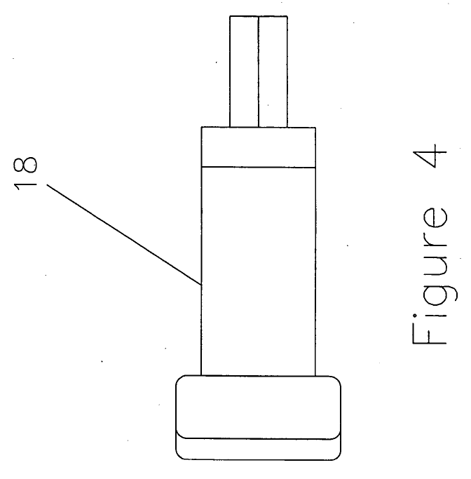

As shown in FIG. 4, in a preferred embodiment, the system also includes a quick change coupler 18 to attach the cooking attachments on to a rotisserie device 20. Referring to FIGS. 1 and 3, in the preferred embodiment, the rotisserie device 20 is an electric powered implement. The rotisserie may either be powered by replaceable batteries or a rechargeable (cordless) battery. In the event of a rechargeable battery, the battery may be recharged via the outlet (cigarette lighter) of a vehicle or by wall outlet charger. The rotisserie will turn the food at a slow and even speed in order to evenly cook the food, without burning the hands of the user.

It is to be noted that the present invention can be used with one of plurality of attachments including those for cooking burgers, sandwiches, marshmallows, etc. The invention is easy to ship, store and carry.

The present invention has been described with reference to the enclosed preferred embodiment. The true nature and scope of the present invention is to be determined with reference to the attached claims.

1. A novel cookout food cooker comprising;
a powered rotisserie device for turning a food item at a predetermined speed over an open fire;
at least one extendable attachment for supporting a food to be cooked; and
a coupler for putting cooking attachments on to the rotisserie device.

2. The novel cookout food holder of claim 1 wherein the extendable attachment comprises an extendable arm with multiple attachment members.

3. The cookout food holder of claim 1 wherein the food is a hot dog.

4. A novel cookout food cooker comprising;
a rechargeable powered rotisserie device for turning a food item to be cooked at a predetermined speed;
at least one of plurality of extendable attachments for supporting a food to be cooked; and
a coupler for putting the attachment on to the rechargeable powered rotisserie device.

5. A novel cookout food cooker comprising;
a rechargeable powered rotisserie device for turning a food item to be cooked at a predetermined speed;
an extendable arm and a plurality of extendable attachments for the arm, each configured to a support a different food item to be cooked; and
a coupler for putting the extendable arm on to the rotisserie device.
